(19) United States
(12) Patent Application Publication
(10) Pub. No.: US 2019/0233007 A1
(43) Pub. Date: Aug. 1, 2019

(54) METHOD FOR OPERATING STEERING SYSTEMS OF MACHINES

(71) Applicant: Caterpillar Paving Products Inc., Brooklyn Park, MN (US)

(72) Inventors: Lee Michael Hogan, Champlin, MN (US); Jason William Muir, Andover, MN (US); Timothy Michael O'Donnell, Long Lake, MN (US); Hyppolite Kuissi, Peoria, IL (US)

(73) Assignee: Caterpillar Paving Products Inc., Brooklyn Park, MN (US)

(21) Appl. No.: 16/380,109

(22) Filed: Apr. 10, 2019

(51) Int. Cl. B62D 15/02

(52) U.S. Cl. CPC B62D 15/024; B62D 5/0457; B62D 15/029

(57) ABSTRACT

A method for operating a machine's steering system having an input device, and components to manipulate the machine's traction devices based on the input device's actuation, includes detecting a condition of at least one component of the components in response to an actuation of the input device; determining a steering angle of the traction devices corresponding to the condition of the component according to a map table; receiving an input to set the steering angle to an actual steering angle; estimating a difference between the actual steering angle and the steering angle determined according to the map table; modifying the map table by shifting each steering angle of the plurality of steering angles with respect to each condition of the plurality of conditions based on the difference to generate an adjusted map table; and outputting the actual steering angle based on the adjusted map table to correspond to the condition.

### TECHNICAL FIELD

The present disclosure relates to steering systems in machines. More particularly, the present disclosure relates to a method for operating such steering systems that includes setting an existing steering angle to an actual steering angle.

### BACKGROUND

Machines, such as rotary mixers, road reclaimers, generally include steering systems that assist with the maneuvering and navigation of the machines from one location to the other. Such steering systems generally include an input device, such as a steering wheel, mini wheel, joystick, and the like, for adjusting the steering angle of one or more tractions devices of the machine while maneuvering. Such steering systems may also include a variety of components operably coupled between the input device and the traction devices, so that an actuating force from the input device and/or the components may be transferred to the traction devices during maneuvering.

During an operational course, or otherwise, an operator of such machines may desire for a straight-line machine travel over ground. Commonly, such machines include systems that may suggest at what steering angle the traction devices (or the machine in general) may be moving at, at any given point. Such steering angles are commonly accessed by the operators through a display or by way of an interface associated with the machine. However, owing to various factors, such as varying machine tolerances, prolonged machine use, etc., a straight-line machine travel suggested by such systems may differ from what the operator considers to be straight path travel of the machine.

German Patent No. 102014226615 relates to a steering system for a vehicle having a steering wheel and a steering drive for setting the orientation of a left and a right wheel hub carrier of a corresponding suspension system of the vehicle. The orientation is set in accordance with a driver's side of the vehicle steering wheel's predetermined steering wheel position.

### SUMMARY OF THE INVENTION

In one aspect, the disclosure is directed towards a method for operating a steering system of a machine. The steering system includes an input device and one or more components to facilitate manipulation of one or more traction devices of the machine based on an actuation of the input device. The method includes detecting, by a sensor, a condition of at least one component of the one or more components in response to an actuation of the input device, and determining, by a controller, a steering angle of the traction devices corresponding to the condition of the component according to a map table. The map table includes multiple steering angles corresponding to multiple conditions of the component. The method further includes receiving, by the controller, an input to set the steering angle determined according to the map table to an actual steering angle and estimating, by the controller, a difference between the actual steering angle and the steering angle determined according to the map table. Furthermore, the method includes modifying, by the controller, the map table by shifting each steering angle of the plurality of steering angles with respect to each condition of the plurality of conditions based on the difference so as to generate an adjusted map table. An output device outputs the actual steering angle based on the adjusted map table to correspond to the condition of the at least one component.

### BRIEF DESCRIPTION OF THE DRAWINGS

FIG. 1 is an exemplary view of a machine with some components of the machine removed to reveal an underlying frame and certain sub-systems, such as a layout of a steering system, of the machine, in accordance with an embodiment of the present disclosure;

FIG. 2 is a schematic representation of the steering system, in accordance with an embodiment of the present disclosure;

FIGS. 3 to 5 are various views illustrating screenshots of a display unit serving, at least in part, as an output device through which an operator of the machine may navigate through various stages of the steering system's operation, in accordance with an embodiment of the present disclosure; and

FIG. 6 is a map table associated with determining a steering angle associated with one or more traction devices of the machine, in accordance with an embodiment of the present disclosure;

FIG. 7 is an adjusted map table, in accordance with an embodiment of the present disclosure; and

FIG. 8 is a flowchart depicting an exemplary method of operation of the steering system, in accordance with an embodiment of the present disclosure.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts.

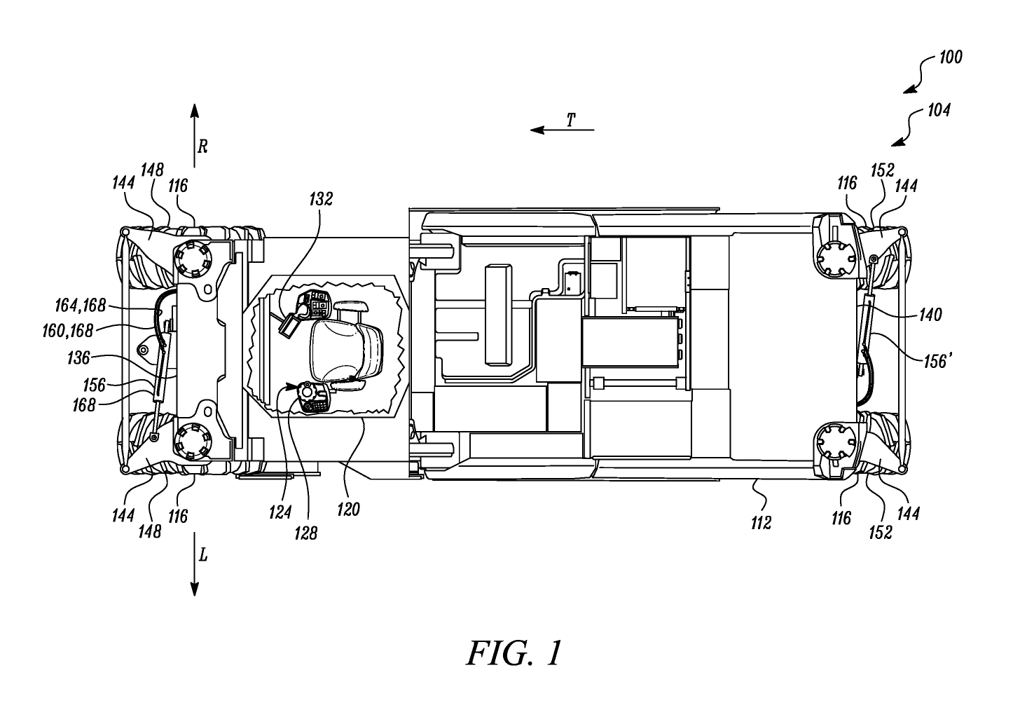

Referring to FIG. 1, an exemplary layout of a machine 100 is illustrated, with several systems and components of the machine 100 removed. The machine 100, as disclosed herein, may embody a rotary mixer machine 104, although other examples of the machine 100 may be contemplated. For example, the machine 100 may represent a recycler, a cold planar, or any other type of milling machine configured to grind or pulverize an underlying work surface (not explicitly shown). Aspects of the disclosure may also be extended to various other machines, such as to pavers, road reclaimers, and track-type tractors. Accordingly, the machine 100, representing a rotary mixer machine 104 herein, need to be seen as being purely exemplary. The work surface on which the machine 100 may ply may be a paved work surface, such as a road surface. Alternatively, the work surface may also include, at least in part, a non-paved surface.

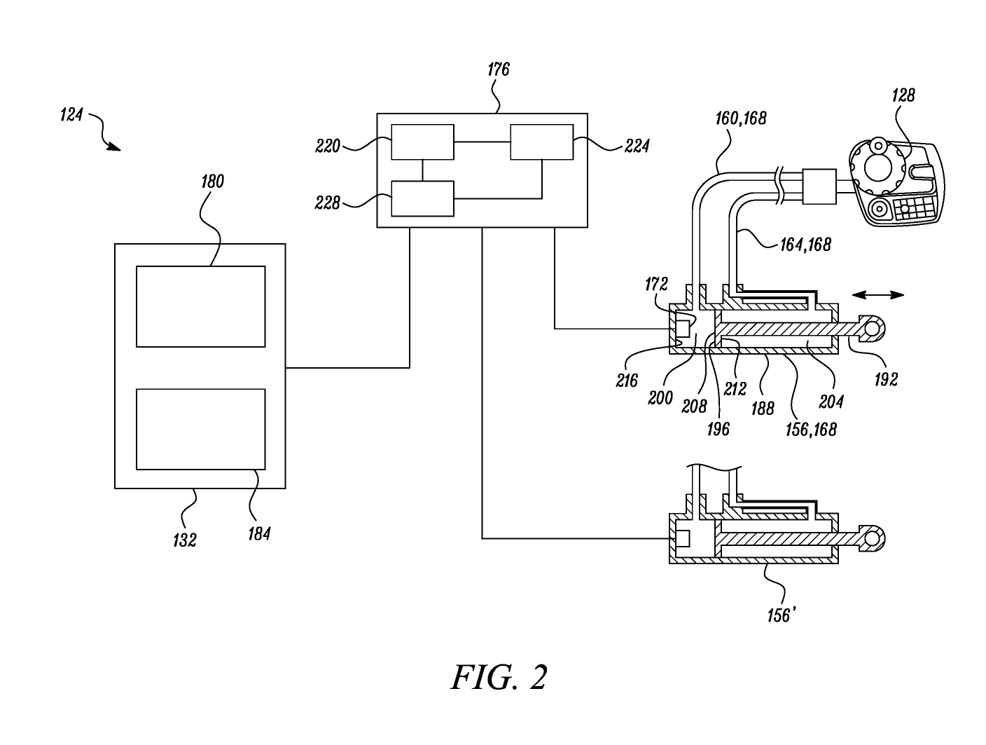

The machine 100 may include a frame 112, traction devices 116, an operator station 120, and a steering system 124 (also see FIG. 2) having components such as an input device 128 and an output device 132 housed within the operator station 120. While the machine 100 may include several other parts and sub-systems, such as a power compartment with a power source (e.g., an internal combustion engine) and a milling assembly (not explicitly shown), aspects of the present disclosure are largely focused towards the frame 112, the traction devices 116, the steering system 124, and the operator station 120.

The frame 112 may include a rigid structure to which nearly every other component (and/or sub-component) of the machine 100 may be coupled to. For example, the frame 112 may support the operator station 120 (also interchangeably referred to as operator cab) that, apart from housing various parts and systems of the steering system 124, may be also applied to accommodate/station one or more operators (not shown) of the machine 100 for the control of the many functions of the machine 100. The frame 112 may define a forward end 136 and a rearward end 140. The terms ‘forward’ and ‘rearward’, as used herein, are in relation to a direction of travel of the machine 100, as represented by arrow, T, in FIG. 1, with said direction of travel being exemplarily defined from the rearward end 140 towards the forward end 136. A movement of the machine 100 (e.g., by way of powering the traction devices 116) may be facilitated by the power source.

The traction devices 116 are operably coupled to the frame 112 (e.g., by way of corresponding swing arms 144), and are configured to receive power for rotation from the power source so as to propel the frame 112 (and thus the machine 100) over and along the work surface. The traction devices 116 may include wheels, although other types of traction devices, such as endless tracks or crawler tracks, may be contemplated for employment either alone or in combination with the wheels. More particularly, the traction devices 116 may include a pair of forward wheels 148 and a pair of rearward wheels 152, as shown. Each of the forward wheels 148 and the rearward wheels 152 may be able to turn about their respective axis so as to enable the machine 100 to move laterally towards the sides (i.e., to the left-hand side and/or to the right-hand side of the machine 100), independently of each other, thereby enabling the machine 100 to be steerable towards either of the sides. The terms left-hand side' and ‘right-hand side’ may be understood as the machine 100 is viewed from the rearward end 140 of the frame 112 towards the forward end 136 of the frame 112, and according to arrow, R, which indicates the right-hand side, and arrow, L, which indicates the left-hand side, as provided in FIG. 1.

Referring to FIGS. 1 and 2, the steering system 124 is configured to power the steering and turning of the forward wheels 148 towards the sides of the machine 100 so as to steer the machine 100 towards those sides during travel. A similar steering system (not shown) may be available to steer the rearward wheels 152, although, in some cases, it is possible for the steering system 124, which powers the steering of the forward wheels 148, to also power the steering of the rearward wheels 152. The forthcoming disclosure will include discussions related to the arrangement and working of the steering system 124 with respect to the forward wheels 148. Such discussions may be equivalently applied to the working of a similar steering system (e.g., the steering system 124 itself) with respect to the rearward wheels 152.

The steering system 124 includes the input device 128 and various components to facilitate manipulation of the forward wheels 148 based on an actuation of the input device 128. The various components of the steering system 124 may include a fluid actuator 156, a first hose 160, and a second hose 164, as shown. Collectively, the fluid actuator 156, the first hose 160, and the second hose 164, may be referred to as components 168. The steering system 124 also includes a sensor 172, a controller 176, the output device 132 having a user interface 180, and a feedback interface 184. Details pertaining to each of the sensor 172, the controller 176, and the output device 132, will be set out later in the disclosure. It may be noted that the fluid actuator 156 may be adapted for manipulation of the forward wheels 148, and that the steering system 124 also includes a similar fluid actuator 156′ that may be adapted for manipulation of the rearward wheels 152. Details related to the fluid actuator 156 have been provided in the disclosure, with equivalent details being applicable for the fluid actuator 156′ for the control and/or manipulation of the rearward wheels 152. Accordingly, the fluid actuator 156′ is neither elaborately annotated nor discussed.

The input device 128 may include one or more of a steering wheel, a mini wheel, a joystick, and/or similar other devices, and may be accessible to an operator stationed within the operator station 120 for the steering control of the forward wheels 148. According to one embodiment, the input device 128 may be operably coupled to the fluid actuator 156 to transfer/alter a fluid housed in the fluid actuator 156, so as to actuate the fluid actuator 156. An actuation of the fluid actuator 156 may in turn actuate the forward wheels 148—i.e., to actuate the simultaneous turning of the forward wheels 148 either towards the left-hand side or the right-hand side, for steering the machine 100.

In further detail, the fluid actuator 156 may embody a cylinder-rod based configuration, and accordingly may include a cylinder 188, and a rod 192 extendable and retractable relative to the cylinder 188. The rod 192 may be fixedly coupled to a piston 196 accommodated within the cylinder 188, with the piston 196 dividing the cylinder 188 into a head end chamber 200 and a rod end chamber 204. The first hose 160 may be coupled (e.g., fluidly) between the input device 128 and head end chamber 200, while and the second hose 164 may be coupled (e.g., fluidly) between the input device 128 and the rod end chamber 204. Fluid may be selectively passed through the first hose 160 and the second hose 164 and may be received into/released out of the head end chamber 200 and the rod end chamber 204, during an actuation of the input device 128.

According to an embodiment, an actuation of the input device 128 includes a movement (e.g., rotation) of the input device 128 either to the left-hand side or to the right-hand side. A movement of the input device 128 to the left-hand side (arrow, L) (FIG. 1) may cause fluid to pass through the first hose 160, fill the head end chamber 200 of the cylinder 188, and push the fluid out from the rod end chamber 204 into the second hose 164 by the fluid exerting force on one side 208 of the piston 196, thus causing the forward wheels 148 to turn to the left-hand side (arrow, L) (FIG. 1). In a similar embodiment, a movement of the input device 128 to right-hand side (arrow, R) (FIG. 1) may cause fluid to pass through the second hose 164, fill the rod end chamber 204 of the cylinder 188, and push the fluid out from the head end chamber 200 into the first hose 160 by the fluid exerting force on an opposite side 212 of the piston 196, thus causing the forward wheels 148 to turn to the right-hand side (arrow, R) (FIG. 1). It may be noted that a movement of the input device 128 to the left-hand side (arrow, L) (FIG. 1) may cause the piston 196 (and the rod 192) to extend out of the cylinder 188, while a movement of the input device 128 to the right-hand side (arrow, R) (FIG. 1) may cause the piston 196 (and the rod 192) to retract into the cylinder 188. Further, the rod 192 may be coupled to the one or more of the swing arms 144 that couple the forward wheels 148 to the frame 112 (FIG. 1), and thus a movement of the rod 192 causes these swing arms 144 to move as well, causing the turning of the forward wheels 148 either to the left-hand side or the right-hand side.

The sensor 172 may be configured to detect a condition of one or more of the components 168 of the steering system 124 so as to facilitate determination of a steering angle of the forward wheels 148 based on the condition. As an example, the sensor 172 may be configured to detect a duty cycle of the fluid actuator 156, and may accordingly help the controller 176 determine a steering angle of the forward wheels 148 based on the duty cycle of the fluid actuator 156. A duty cycle of the fluid actuator 156 may be computed in percentage and may be understood from the following example—a maximum extension of the piston 196 or rod 192 out of the cylinder 188 may correspond to a 95% duty cycle of the fluid actuator 156, while a maximum retraction of the piston 196 or the rod 192 into the cylinder 188 may correspond to a 5% duty cycle of the fluid actuator 156. It may be noted that at the 95% duty cycle of the fluid actuator 156, the forward wheels 148 may be turned maximum towards the left-hand side (arrow, L) (FIG. 1), while at the 5% duty cycle of the fluid actuator 156, the forward wheels 148 may be turned maximum towards the right-hand side (arrow, R) (FIG. 1).

To detect the duty cycle of the fluid actuator 156, and according to one example, the sensor 172 may be adapted to detect a position of the piston 196 with respect to an end 216 of the cylinder 188. To this end, the sensor 172 may be a proximity sensor that may detect a proximity (or distance) by which the piston 196 may be separated from the end 216, at any given point. Based on the distance, the position of the piston 196 (and/or the rod 192) with respect to the end 216 may be computed, and thus an extent to which the piston 196 has moved, either to extend out or to retract in with respect to the cylinder 188, may be deduced, and, accordingly, a duty cycle of the fluid actuator 156 may be detected. Alternatively, the sensor 172 may be a mass flow sensor that may also determine the flow of fluid in one or more directions. Since a quantity of fluid entering or leaving the head end chamber 200, for example, may be considered to be directly proportional to the extent of movement of the piston 196 relative to the end 216, a position of the piston 196 may be computed by detecting the mass flow of fluid (e.g., along with the direction of fluid flow), and thus a duty cycle of the fluid actuator 156 may be accordingly detected. The sensor 172 may be accommodated within the cylinder 188, at the end 216 of the cylinder 188, although other sensor positions may be contemplated. For example, the sensor 172 may be mounted to the outside of the cylinder 188 or at various other positions on the fluid actuator 156 to perform one or more of the aforementioned tasks.

It may be noted that various other means of detecting/computing the duty cycle of the fluid actuator 156 may be contemplated, and the ones discussed above, by use of the sensor 172, are purely exemplary. Further, it is to be noted that the employment of the fluid actuator 156 and the determination of the duty cycle of the fluid actuator 156 to help the controller 176 determine the steering angle of the forward wheels 148, is also one among the many ways of determining the steering angle of the forward wheels 148, and thus the same also needs to be viewed as being exemplary. This is because the present disclosure contemplates various other ways and possibilities of helping the controller 176 determine the angle of the forward wheels 148—according to one example, the sensor 172 may include a rotary sensor that may be able to determine a degree of rotation of the input device 128 (when, for example, a steering wheel or a mini wheel is utilized as the input device 128). Based on the degree of rotation, the controller 176 may determine the steering angle of the forward wheels 148. Various other similar examples may be contemplated.

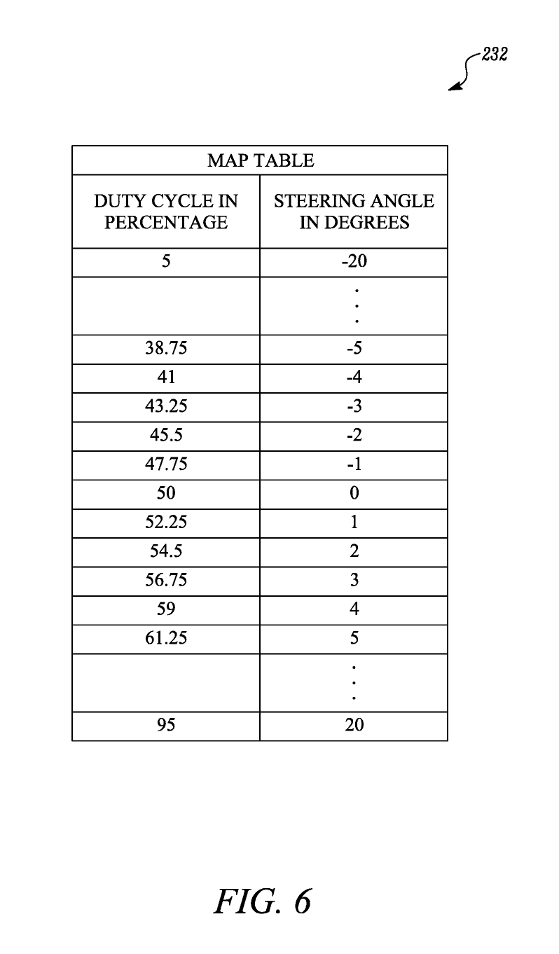

The controller 176 may be communicably coupled to the sensor 172, so as to receive the various signals (such as signals associated with the duty cycle of the fluid actuator 156) from the sensor 172. The controller 176 may include a processor 220, a transceiver 224, and a memory 228. Considering the above example of detecting the duty cycle of the fluid actuator 156 to determine the steering angle of the forward wheels 148, the controller 176, once having received the one or more signals (pertaining to the duty cycle) from the sensor 172, may retrieve a map table 232 (FIG. 6) stored within the memory 228. The map table 232 may include one or more tabulations or charts where multiple steering angles may correspond to multiple conditions of the component (in this case, the multiple duty cycles of the fluid actuator 156). In other words, every condition (e.g., duty cycle) of the component (e.g., the fluid actuator 156) may correspond to a particular steering angle of the forward wheels 148.

According to an example, when the piston 196 is halfway through the cylinder 188, the sensor 172 may determine that the piston 196 is at a center position with respect to the cylinder 188, and (either the controller 176 or the sensor 172 itself) may accordingly assign a value of 50% duty cycle to the fluid actuator 156. This data is delivered to and is processed by the controller 176, where when this 50% condition of the fluid actuator 156 is tallied within the map table 232, the controller 176 determines that the 50% condition (or the 50% duty cycle) of the fluid actuator 156 co-relates or corresponds to a specific angle of the forward wheels 148. For example, the map table 232 (FIG. 6) may include a 0 degree steering angle corresponding to the 50% condition (or duty cycle) of the fluid actuator 156. Accordingly, the controller 176 determines that the steering angle to which the forward wheels 148 may have turned to is 0 degree. Since at 5% duty cycle, the forward wheels 148 may be turned maximum towards the right-hand side (arrow, R) (FIG. 1), and at 95% duty cycle, the forward wheels 148 may be turned maximum towards the left-hand side (arrow, L) (FIG. 1), it will be appreciated and understood that at 50% duty cycle (i.e., at 0 degree steering angle) (determined according to the map table 232), the controller 176 may determine that the forward wheels 148 are ‘straight’ and that the machine 100 may travel along a straight path on the work surface.

For the purposes of the disclosure, such determination by the controller 176 may be termed as ‘machine defined straight path travel’. Further, it may be also exemplarily noted that at 95% duty cycle (i.e., when the forward wheels 148 may be turned maximum towards the left-hand side) a steering angle determined by the controller 176 according to the map table 232 is exemplarily +20 degrees, while at 5% duty cycle (i.e., when the forward wheels 148 may be turned maximum towards the right-hand side) a steering angle determined by the controller 176 according to the map table 232 is exemplarily −20 degrees. While various aspects in relation to the map table 232 have been discussed and covered above, it may be noted that the values noted in the map table 232 may change according to machine type and specification, and thus, the values within the map table 232 need to be viewed as exemplary.

The output device 132 may be communicably coupled to the controller 176 so as to receive instructions from the controller 176. For example, the output device 132 may serve to output (e.g., dynamically or in real time) various steering angles determined by the controller 176 of the forward wheels 148 via the feedback interface 184 (of the output device 132).

The feedback interface 184 may include a display unit or a speaker unit, or both, to output the steering angle either by display, speech, by both, or by other conventional methods, to one or more operators of the machine 100. While the feedback interface 184 may be housed within the operator station 120 as suggested above, optionally, the feedback interface 184 may be deployed remote to the machine 100, for example, at a central server station or a monitoring station associated with the machine 100—this may be applicable if the machine 100 is a semi-autonomous or a fully autonomous machine and/or if no operator is present within the machine 100 during operations. In case the feedback interface 184 is remote to the machine 100, the feedback interface 184 may be in communication with the controller 176 wirelessly, and the steering angle may be outputted via the feedback interface 184 and provided to one or more supervisors remotely monitoring (and/or controlling) the activities and operation of the machine 100. Optionally, the controller 176 may also be deployed at a remote site either in proximity to the feedback interface 184 or away from the feedback interface 184, and, in some cases, the controller 176 may be hard-wired to the feedback interface 184.

According to an embodiment of the present disclosure, the controller 176 is further configured to receive an input to set the steering angle (determined according to the map table 232 and outputted through the feedback interface 184 of the output device 132) to an auxiliary steering angle. Although not limited, this auxiliary steering angle may include an actual steering angle that may be set by an operator/supervisors of the machine 100 if the operator/supervisors perceive that the steering angle determined according to the map table 232 by the controller 176, at any given point, is inaccurate or inappropriate. For example, if the operator observes that a straight path travel of the machine 100 (or what the operator perceives to be 0 degree steering angle of the forward wheels 148), differs (e.g., minimally) from the machine defined straight path travel (as observed through the feedback interface 184 of the output device 132), the operator/supervisors may provide an input to the controller 176 to set any further forward travel of the machine 100 according to an operator defined straight path travel (i.e., the operator/supervisors may set the steering angle of the forward wheels 148, determined according to the map table 232 by the controller 176, to an actual steering angle).

As an example, if the controller 176 determines that the steering angle of the forward wheels 148, at any given point, is −1 degree and the same is outputted by the feedback interface 184 of the output device 132 as −1 degree steering angle, and if it is perceived by the operator/supervisors that the travel of the machine 100 is instead at 0 degree steering angle, then the operator/supervisors may set the −1 degree steering angle (i.e., the steering angle determined according to the map table 232) of the forward wheels 148 to 0 degree steering angle (i.e., to the actual steering angle) of the forward wheels 148. An exemplary manner of setting the steering angle (derived through the map table 232) to the actual steering angle, is discussed below.

According to an embodiment of the present disclosure, the actual steering angle may be fed into the controller 176 through the user interface 180 of the output device 132. For this purpose, the controller 176 may be coupled to the user interface 180 so as to receive the actual steering angle from the user interface 180. The user interface 180 may include an analogue based interface or a digitized interface (including a touchscreen, etc.), or both, into which an operator of the machine 100 may feed-in the actual steering angle. Other ways of feeding the actual steering angle into the user interface 180, such as by voice control or activation, etc., may be contemplated. It may be noted that the actual steering angle may be fed into the user interface 180 either through an operator stationed within the operator station 120, or through supervisors deployed remote to the machine 100. Thus, like the feedback interface 184, the user interface 180 may also be positioned either within the operator station 120 or at a remote site. In some cases, it may be noted that the user interface 180 may be outside the output device 132 and/or may function independently of the feedback interface 184 deployed as part of the output device 132. In some cases, such interfaces may be provided at both locations, i.e., within the operator station 120 and also at the remote site. According to yet another embodiment, the user interface 180 and the feedback interface 184 may be integrated into one and the same device, and such may be combinedly referred to as the output device 132.

Having received the actual steering angle, the controller 176 may be configured to estimate a difference between the actual steering angle and the steering angle determined according to the map table 232. As an example, if the steering angle determined by the controller 176 according to the map table 232 is −1 degree (i.e., for 47. 75% duty cycle) (see FIG. 6), and the actual steering angle, when perceived by the operator/supervisors for a straight path machine travel, amounts to 0 degree (i.e., the operator defined straight path travel), the controller 176 may estimate the difference between the actual steering angle (i.e., 0 degree) and the steering angle (i.e., −1 degree), determined according to the map table 232, to be equal to ‘−1’ according to the following exemplary equation:
[steering angle according to map table 232−actual steering angle]
   which in the present example may be understood as the following:

[(−1)−0]=−1

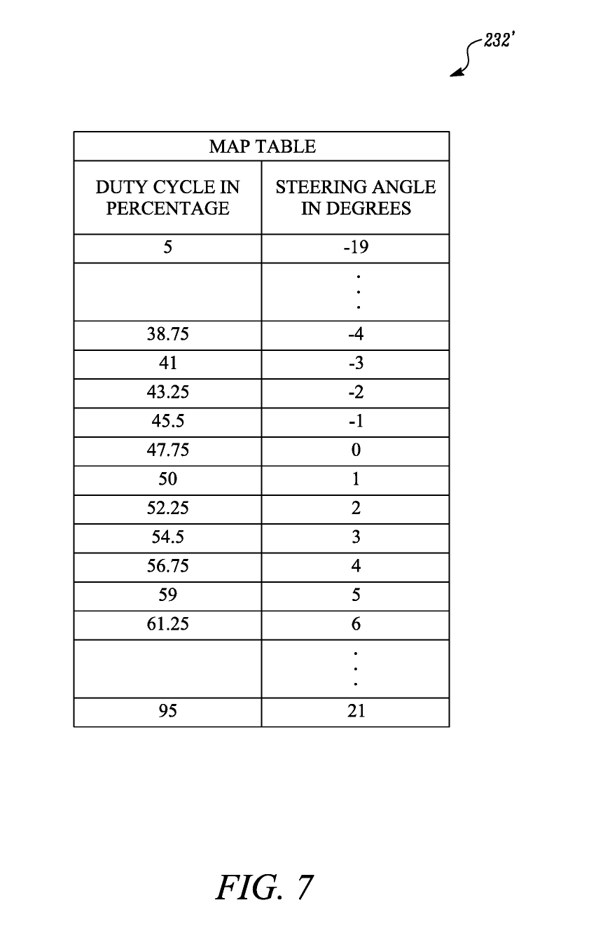

Once this difference is estimated, the controller 176 modifies the map table 232 based on this difference. For example, the controller 176 modifies the map table 232 by shifting (or deducting) each steering angle of the multiple steering angles with respect to each condition (e.g., duty cycle) of the multiple conditions (e.g., the multiple duty cycles of the fluid actuator 156) based on this difference. In that manner, the controller 176 generates an adjusted map table 232′ (FIG. 7). According to the present example, therefore, the steering angle corresponding to every duty cycle of the fluid actuator 156 in the map table 232 is subtracted by ‘−1’, i.e., by the difference estimated by the controller 176. Therefore, when comparing FIGS. 6 and 7, the 47. 75% duty cycle that corresponded to −1 degree steering angle of the forward wheels 148 according to the map table 232 (FIG. 6), may correspond to 0 degree steering angle according to the adjusted map table 232′ (FIG. 7). Exemplary adjustments with regard to other steering angles corresponding to the various duty cycles of the fluid actuator 156 may also be noted by comparing FIG. 6 with FIG. 7.

Once the adjusted map table 232′ is generated, the controller 176 may relay (i.e., to deliver) the steering angle of the forward wheels 148 according to the adjusted map table 232′ to the feedback interface 184 of the output device 132. Therefore, if the fluid actuator 156 were at 47. 75% duty cycle, the feedback interface 184 of the output device 132 (that would have outputted the steering angle of the forward wheels 148 as −1 degree according to the map table 232 of FIG. 6) may output the steering angle of the forward wheels 148 as 0 degree based on the adjusted map table 232′ of FIG. 7.

The controller 176 may be connected to the machine's (i.e., the machine 100) electronic control module (ECM) (not shown), such as a safety module or a dynamics module, or may be configured as a stand-alone entity. Optionally, the controller 176 may be integral and be one and the same as the ECM. The controller 176 may include a set of volatile memory units such as a random-access memory (RAM)/a read-only memory (ROM), which include associated input and output buses. More particularly, the controller 176 may be a microprocessor based device, and/or may be envisioned as an application-specific integrated circuit, or other logic devices, which provide controller functionality, and such devices being known to those with ordinary skill in the art. In one example, it is possible for the controller 176 to include or be representative of one or more controllers having separate or integrally configured processing units to process a variety of data (or input) received from the sensor 172. For example, the output device 132 (either or both of the user interface 180 and the feedback interface 184) may include a controller (such as a display ECM) separate/independent from the controller 176. Further, the controller 176 may also include one or more internally (or externally) configured memories (as already suggested above). Further, the controller 176 may be optimally suited for accommodation within certain machine panels or portions from where the controller 176 may remain accessible for ease of use, service, and repairs.

Processing units, to convert and/or process the signals from the sensor 172 and configured within the controller 176, may include, but are not limited to, an X86 processor, a Reduced Instruction Set Computing (RISC) processor, an Application Specific Integrated Circuit (ASIC) processor, a Complex Instruction Set Computing (CISC) processor, an Advanced RISC Machine (ARM) processor or any other processor. Examples of the memories may include a hard disk drive (HDD), and a secure digital (SD) card.

### INDUSTRIAL APPLICABILITY

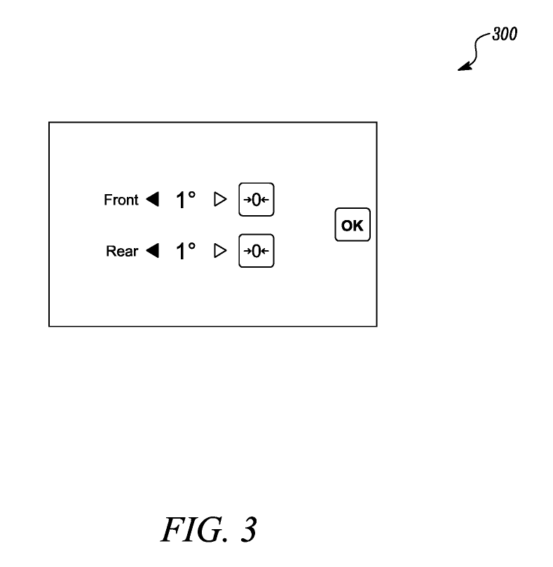

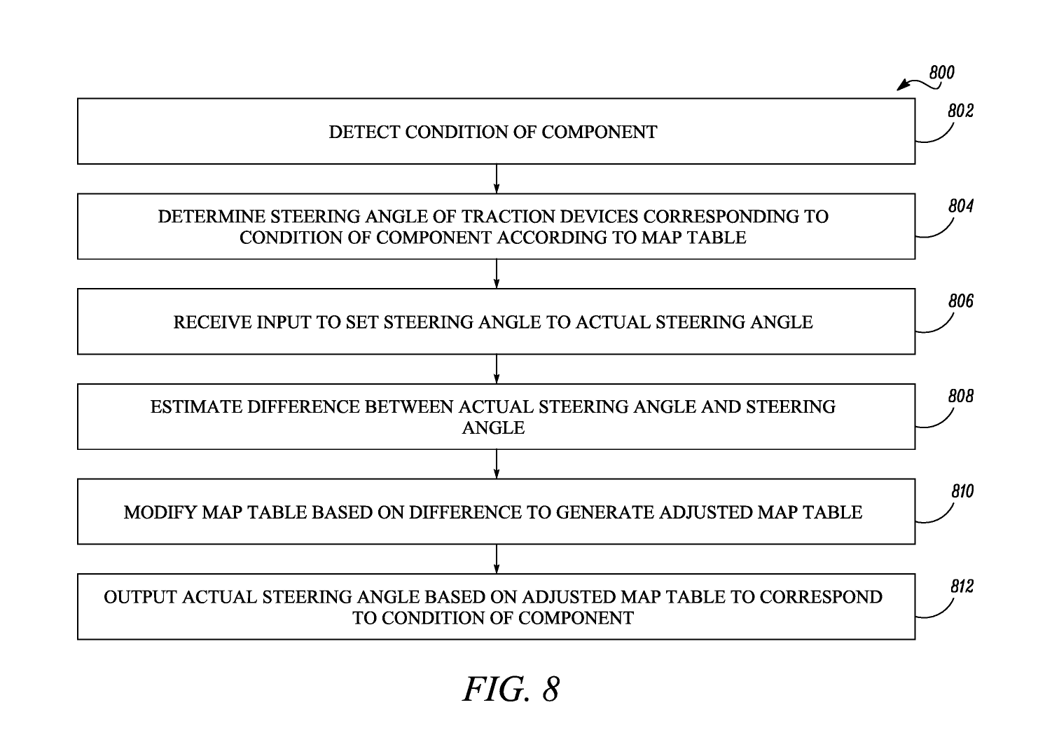

Referring to FIG. 8, an exemplary method of operating the steering system 124 of the machine 100 is discussed. The method is discussed by way of a flowchart 800, as provided in FIG. 8, that illustrates exemplary stages (i.e., from 802 to 812) associated with the method. The method is also discussed in conjunction with exemplary screenshots 300, 400, 500 of the feedback interface 184/user interface 180 that are provided in FIGS. 3, 4, and 5.

During operation, considering that the output device 132, having the user interface 180 and the feedback interface 184, is deployed within the operator station 120 of the machine 100, at stage 802, the sensor 172 may detect a condition (i.e., a duty cycle) of a component (e.g., the fluid actuator 156) of the components 168 in response to an actuation of the input device 128. To this end, the sensor 172 may itself include one or more processing units, such as those discussed for the controller 176, that may assist with the detection of the duty cycle of the fluid actuator 156 corresponding to the position of the piston 196/rod 192. Alternatively, it is possible for the sensor 172 to detect a position of the piston 196/rod 192, and, thereafter, relay or transmit data related to the position to the controller 176, and the controller 176 may in turn assist with the detection of the duty cycle corresponding to the position of the piston 196/rod 192.

At stage 804, the controller 176 determines a steering angle of the forward wheels 148 corresponding to or based on the condition of the at least one component (i.e., corresponding to or based on the duty cycle of the fluid actuator 156) according to the map table 232. Once the controller 176 determines the steering angle corresponding to the duty cycle of the fluid actuator 156, the controller 176 may transmit the steering angle to the feedback interface 184 so that one or more operators stationed within the operator station 120 may access the feedback interface 184 and take note of the steering angle of the forward wheels 148 determined according to the map table 232 by the controller 176. As noted above, the feedback interface 184 may output or provide the steering angle of the forward wheels 148 by way of a display (see an exemplary screenshot 300 of a display screen of the feedback interface 184 provided in FIG. 3)—it may be noted that the exemplary screenshot 300 includes steering angles corresponding to the forward wheels 148 as well as the rearward wheels 152.

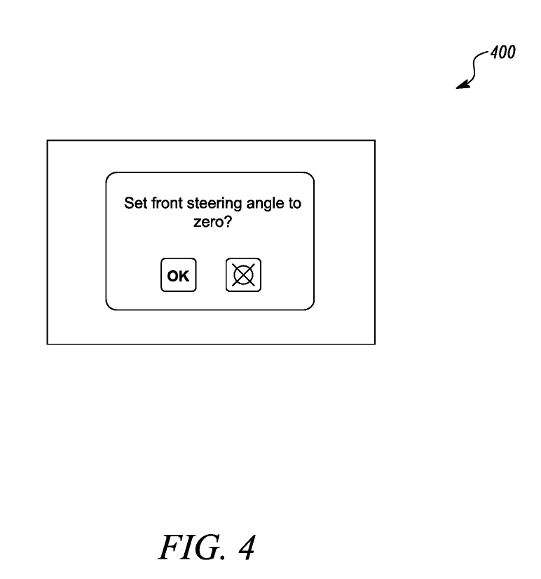

At stage 806, the one or more operators stationed within the operator station 120 may perceive a straight path travel of the machine 100, but which may be indicated by the controller 176 as a non-zero steering angle through the feedback interface 184. At this point, one or more of the operators/supervisors may desire to set this non-zero steering angle (determined by the map table 232) to an actual steering angle that equals to 0 degree steering angle (because a 0 degree steering angle ideally corresponds to the straight path travel of the machine 100). As a result, the operators may set the non-zero steering angle to 0 degree steering angle by way of the user interface 180. FIG. 4 depicts an exemplary screenshot 400 of a pop-up window on a display of the user interface 180 through which the operator confirmation is sought for proceeding to set the steering angle to 0 degree. It may be noted that in this case the user interface 180 and the feedback interface 184 are integrated to be part of one and the same device, i.e., the output device 132. Effectively, at stage 806, the controller 176 receives an input (from the operators) to set the steering angle determined according to the map table 232 to the actual steering angle.

In some embodiments, the operators may use some arrangements to confirm whether their perception of straight path travel of the machine 100 is accurate. For example, the operators may use a laser based device (not shown), that, for example, may detect an alignment of the forward wheels 148 in relation to the frame 112 to confirm their perception of straight path travel of the machine 100, and only upon such confirmation may the operators proceed to set the steering angle to the actual steering angle (i.e., 0 degree).

At stage 808, the controller 176 estimates a difference between the actual steering angle and the steering angle determined according to the map table 232, and, at stage 810, the controller 176 modifies the map table 232 by shifting each steering angle of the multiple steering angles with respect to each condition of the multiple conditions based on the difference—compare FIGS. 6 and 7 with each other. In that manner, the controller 176 generates the adjusted map table 232′ provided in FIG. 7.

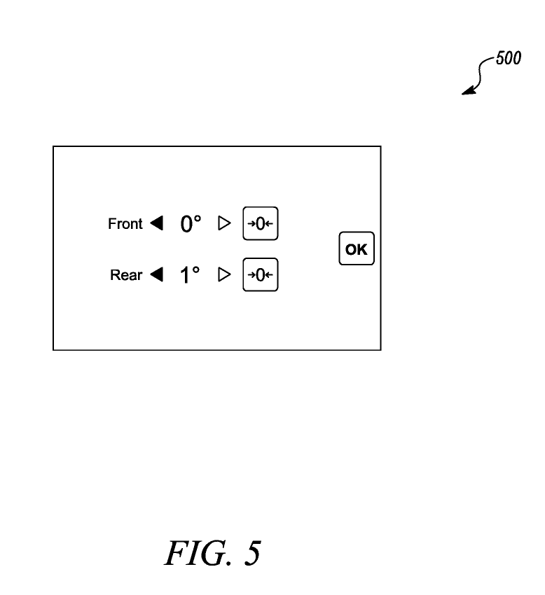

At stage 812, the feedback interface 184 of the output device 132, outputs the steering angle based on the adjusted map table 232′. The steering angle is outputted (e.g., by display of the feedback interface 184) to the operators as exemplary screenshot 500 (FIG. 5). This adjusted steering angle may correspond to the same duty cycle of the fluid actuator 156 for which the non-zero steering angle was determined by the controller 176 according to the map table 232 (FIG. 6).

A method of setting an operator defined straight path travel of the machine 100 may also depend upon what angle the rearward wheels 152 are set at. Thus, it is possible for the operators of the machine 100 to set the steering angles of both the forward wheels 148 and the rearward wheels 152 to 0 degree as an when they perceive that the machine 100 is travelling along a straight path. As suggested above, a method of setting the steering angle of the rearward wheels 152 to 0 degree may be understood to remain similar to what has been discussed for the setting of the steering angle to 0 degree for the forward wheels 148.

By way of the steering system 124, and according to the aforementioned exemplary method of operation of the steering system 124, an operator has the discretion to set the steering angle of the forward wheels 148 (and the rearward wheels 152) to an operator defined angle that sets a path for machine travel that according to the operator may be straight path travel (i.e., the operator defined straight path travel). Such a provision reduces working inaccuracies and operator effort, improves operator comfort, and inevitably leads to better machine utilization and worksite productivity.

It will be apparent to those skilled in the art that various modifications and variations can be made to the system of the present disclosure without departing from the scope of the disclosure. Other embodiments will be apparent to those skilled in the art from consideration of the specification and practice of the system disclosed herein. It is intended that the specification and examples be considered as exemplary only, with a true scope of the disclosure being indicated by the following claims and their equivalent.

What is claimed is:

1. A method for operating a steering system of a machine, the steering system including an input device and one or more components to facilitate manipulation of one or more traction devices of the machine based on an actuation of the input device, the method comprising:
detecting, by a sensor, a condition of at least one component of the one or more components in response to the actuation of the input device;
determining, by a controller, a steering angle of the one or more traction devices corresponding to the condition of the at least one component according to a map table, the map table including a plurality of steering angles corresponding to a plurality of conditions of the at least one component;
receiving, by the controller, an input to set the steering angle determined according to the map table to an actual steering angle;
estimating, by the controller, a difference between the actual steering angle and the steering angle determined according to the map table;
modifying, by the controller, the map table by shifting each steering angle of the plurality of steering angles with respect to each condition of the plurality of conditions based on the difference to generate an adjusted map table; and
outputting, by an output device, the actual steering angle based on the adjusted map table to correspond to the condition of the at least one component.
